(19) United States
(12) Patent Application Publication
(10) Pub. No.: US 2026/0139892 A1
(43) Pub. Date: May 21, 2026

(54) REFRIGERATOR AND HOME APPLIANCE

(71) Applicant: LG Electronics Inc., Seoul (KR)

(72) Inventors: Minho LEE, Seoul (KR); Younseok LEE, Seoul (KR); Sanggyun LEE, Seoul (KR); Jaeun SHIN, Seoul (KR)

(21) Appl. No.: 19/394,315

(22) Filed: Nov. 19, 2025

(30) Foreign Application Priority Data
Nov. 20, 2024 (KR) 10-2024-0166171

(51) Int. Cl. F25D 23/02; E05D 3/12

(52) U.S. Cl. CPC F25D 23/028; E05D 3/12; E05Y 2201/638; E05Y 2201/682; E05Y 2900/31; F25D 2323/024

(57) ABSTRACT

A home appliance includes: a cabinet; a main door; a sub door rotatable with respect to the main door; a main hinge device configured to allow the main door to rotate with respect to the cabinet; and a sub hinge device configured to allow the sub door to rotate with respect to the main door. The main hinge device includes a hinge body installed at the cabinet, a pin unit provided at the hinge body or the main door, and a pin slot in which the pin unit is received and provided at another of the hinge body and the main door. The sub hinge device includes a hinge pin that provides a rotation center for the sub door, and during an opening process of the main door, relative positions of the pin slot and the pin unit vary, and a rotation center of the main door moves.

### CROSS-REFERENCE TO RELATED APPLICATIONS

This application claims the benefit of Korean Patent Application No. 10-2024-0166171, filed on Nov. 29, 2024. The disclosure of the prior application is incorporated by reference in its entirety.

### BACKGROUND

The present disclosure relates to a refrigerator and a home appliance.

In general, a refrigerator is a home appliance for storing foods in an internal storage space, which is shield by a door, at a low temperature by low temperature air. For this, the refrigerator is configured to accommodate the food in an optimum state by cooling the internal storage space using cold air generated through heat exchange with a refrigerant circulating in a refrigeration cycle.

The refrigerator may be independently placed in a kitchen or living room or may be accommodated in a space defined by a furniture cabinet of the kitchen.

The refrigerator may include a cabinet having a storage space and a door connected to the cabinet to open and close the storage space.

For example, if the refrigerator is installed inside the furniture cabinet, there is a risk that the door may hit the furniture cabinet during an opening process, which may limit an opening angle of the door.

Recently, a hinge structure has been developed to prevent the door from interfering with surrounding structures such as a furniture cabinet during a door opening process.

There is a prior art document of International Publication No. WO2019/007278A1.

However, the prior art document only discloses a hinge structure of a single door, and does not disclose a hinge structure in a case where the door is composed of a first door and a second door rotatable with respect to the first door.

### SUMMARY

One embodiment provides a refrigerator in which an opening angle of the main door increases when the door includes a main door and a sub door.

Alternatively or additionally, one embodiment provides a refrigerator in which interference with surrounding structures is prevented during an opening process of the main door.

Alternatively or additionally, one embodiment provides a refrigerator in which interference with the main door and surrounding structures is prevented during an opening process of the sub door.

A refrigerator according to one aspect may include a cabinet having a storage space; a main door that opens and closes the storage space; a sub door rotatable with respect to the main door; a main hinge device to allow the main door to rotate with respect to the cabinet; and a sub hinge device to allow the sub door to rotate with respect to the main door.

The main hinge device may include a hinge body installed at the cabinet, a pin unit provided at one of the hinge body and the main door, and a pin slot in which the pin unit is received and provided at another of the hinge body and the main door.

The sub hinge device may include a hinge pin that provides a rotation center for the sub door. The sub hinge device may further include a bushing that receives the hinge pin.

During an opening process of the main door, relative positions of the pin slot and the pin unit may be varied and a rotation center of the main door may be moved.

During a rotation process of the sub door, a rotation center of the sub door may be fixed in position.

In a state in which the main door is closed, at least a portion of the hinge pin may be positioned closer to a front surface of the sub door than the pin slot.

In a state in which the main door is closed, the hinge pin may be positioned closer to a front surface of the sub door than the pin unit.

When a side surface of the sub door adjacent to the sub hinge device among both side surfaces of the sub door is referred to as a first side surface, in a state in which the main door is closed, at least a portion of the hinge pin may be positioned closer to the first side surface than the pin slot, or at least a portion of the pin slot may be positioned closer to the first side surface than the hinge pin.

When a side surface of the sub door adjacent to the sub hinge device among both side surfaces of the sub door is referred to as a first side surface, in a state in which the main door is closed, the hinge pin may be positioned closer to the first side surface than the pin unit, or the pin unit may be positioned closer to the first side surface than the hinge pin.

In at least a period of an entire opening period of the main door, a rotation center of the main door may be positioned farther from a front surface of the cabinet than a rotation center of the sub door.

The main door includes an extension extending from a front surface of the main door toward the sub door, and at least a portion of the pin slot may be positioned at the extension or at least a portion of the pin unit may be positioned at the extension.

The sub door includes a hinge mounting portion at which the extension is positioned, and at least a portion of the hinge pin may be positioned at the hinge mounting portion.

At least a portion of the pin slot may overlap the sub door in a vertical direction.

The sub hinge device may further include a first bushing provided at the main door and a second bushing provided at the sub door. The hinge pin may be received in the second bushing by passing through the first bushing.

The sub hinge device may further include a first bushing provided at the main door and a second bushing provided at the sub door, and the hinge pin may include a first pin received in the first bushing and a second pin received in the second bushing.

The pin unit may include a first pin and a second pin that are spaced apart from each other, and the first pin and the second pin may be received in the pin slot.

The pin unit may include a first pin and a second pin that are spaced apart from each other, and the pin slot may include a first slot that receives the first pin, and a second slot that is partitioned from the first slot and receives the second pin.

In a period of an entire opening period of the main door, a rotation center of the main door may move away from a front surface of the cabinet. In another period of the entire opening period of the main door, the rotation center of the main door may move toward the front surface of the cabinet.

In a period of the entire opening period of the main door, the rotation center of the main door may be positioned outside the sub door and the main door.

According to another aspect, a refrigerator comprises: a cabinet having a storage space; a main door that opens and closes the storage space; a sub door rotatable with respect to the main door; a main hinge device to allow the main door to rotate with respect to the cabinet; and a sub hinge device to allow the sub door to rotate with respect to the main door, wherein the main hinge device comprises: a hinge body installed at the cabinet; first and second pins provided at one of the hinge body and the main door and spaced apart from each other; and a pin slot in which the first and second pins are received and provided at another of the hinge body and the main door.

The sub hinge device may include a hinge pin that provides a rotation center of the sub door and is spaced apart from the first pin and the second pin. The sub hinge device may further include a bushing that receives the hinge pin.

In a state in which the main door is closed, the hinge pin may be positioned closer to a front surface of the sub door than the first pin and the second pin.

In a state in which the main door is opened by a maximum opening angle, the hinge pin may be positioned closer to a front surface of the sub door than the first pin and second pin.

In a state in which the main door is opened by a maximum opening angle, the first pin and second pin may be positioned closer to a front surface of the sub door than the hinge pin.

The configuration of the refrigerator described above can be applied to a home appliance as well. That is, a home appliance according to one aspect may include a cabinet having a storage space; a main door that opens and closes the storage space; a sub door rotatable relative to the main door; a main hinge device to allow the main door to rotate relative to the cabinet; and a sub hinge device to allow the sub door to rotate relative to the main door.

According to one embodiment, a main door opens as a rotation center of the main door moves, thereby providing an advantage in that an opening angle of the main door increases.

According to one embodiment, a rotation center of the main door can be moved away from one surface of a furniture cabinet, so that the main door can be prevented from interfering with surrounding structures during an opening process of the main door.

### BRIEF DESCRIPTION OF THE DRAWINGS

FIG. 1 is a drawing showing a refrigerator received in a furniture cabinet according to a first embodiment.

FIG. 2 is a perspective view of a refrigerator according to a first embodiment.

FIG. 3 is a perspective view of a first door according to a first embodiment.

FIG. 4 is a perspective view showing an upper main hinge device and an upper sub hinge device connected to a main door according to a first embodiment.

FIG. 5A is an exploded perspective view of an upper main hinge device and an upper sub hinge device, and FIG. 5B is an exploded perspective view of a lower main hinge device and a lower sub hinge device.

FIG. 6 is a plan view showing an upper main hinge device and an upper sub hinge device connected to a main door.

FIG. 7 is a cross-sectional view taken along line 7-7 of FIG. 6.

FIG. 8 is a cross-sectional view taken along line 8-8 of FIG. 2.

FIG. 9 is a drawing showing a process of coupling a main door and a sub door.

FIG. 10 is a drawing showing a manipulating portion installed at a lower side of a sub door.

FIG. 11A is a drawing showing a locking device installed at a sub door, and FIG. 11B is a drawing showing a manipulating portion installed at a sub door.

FIG. 12 is a drawing showing a state in which a locking portion is hooked to a hook portion of a main door.

FIG. 13A is a drawing showing a state in which a main door and a sub door are closed, and FIG. 13B is a drawing showing a state in which a main door is opened by a first angle.

FIG. 14A is a drawing showing a state in which a main door is opened by a second angle greater than a first angle, and FIG. 14B is a drawing showing a state in which a main door is opened by a third angle greater than a second angle.

FIG. 15 is a drawing showing a state in which a main door is opened by a maximum opening angle.

FIGS. 16A to 16D are drawings illustrating a rotation of a sub door in a state in which a main door is closed.

FIG. 17A is a perspective view of a first door according to a second embodiment, and FIG. 17B is a drawing showing a sub hinge device according to a second embodiment.

FIG. 18 is an exploded perspective view of a sub hinge device according to a second embodiment.

FIG. 19 is a cross-sectional view taken along line 19-19 of FIG. 17B.

FIG. 20 is a cross-sectional view taken along line 20-20 of FIG. 19.

FIG. 21 is a cross-sectional view taken along line 21-21 of FIG. 19.

FIG. 22 is a plan view showing a first door according to a third embodiment.

FIG. 23 is a drawing showing a state in which a main door is opened by a maximum opening angle according to a third embodiment.

FIG. 24 is a perspective view showing a main hinge device according to a fourth embodiment.

FIG. 25A shows a first modified example of a first door, and FIG. 25B shows a second modified example of a first door.

FIG. 26A illustrates a third modified example of a first door, and FIG. 26B illustrates a fourth modified example of a first door.

FIGS. 27A to 27E are drawings showing various embodiments of an arrangement between a pin slot of a main door and a hinge pin of a sub door.

### DETAILED DESCRIPTION

Hereinafter, some embodiments of the present disclosure will be described in detail with reference to the accompanying drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a) and (b) may be used. Each of the terms is merely used to distinguish the corresponding component from other components, and does not delimit an essence, an order or a sequence of the corresponding component. It should be understood that when one component is “connected”, “coupled” or “joined” to another component, the former may be directly connected, coupled or jointed to the latter or may be “connected”, coupled” or “joined” to the latter with a third component interposed therebetween.

Hereinafter, a refrigerator is described as an example of a home appliance, but it should be noted that a refrigerator door and a hinge device for rotating the door can be applied equally to home appliances that include doors other than refrigerators.

In this specification, a front surface of a sub door is a surface forming a front surface appearance of a first door, and a rear surface of the sub door is a surface facing a main door.

A front surface of the main door forms an exterior of a front surface of the main door and is a surface facing the rear surface of the sub door. A rear surface of the main door is a surface facing a cabinet or storage space.

A forward direction of the main door is a direction from the main door to the sub door, and a rearward direction of the main door is a direction toward the cabinet or storage space from the main door.

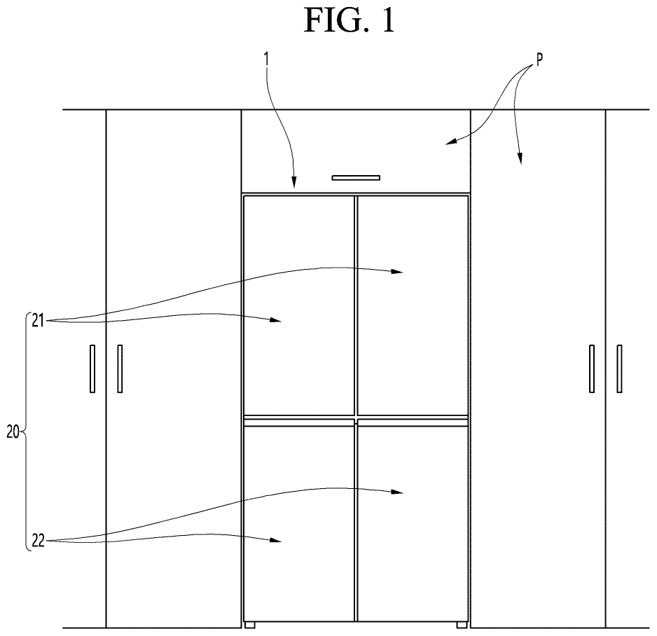

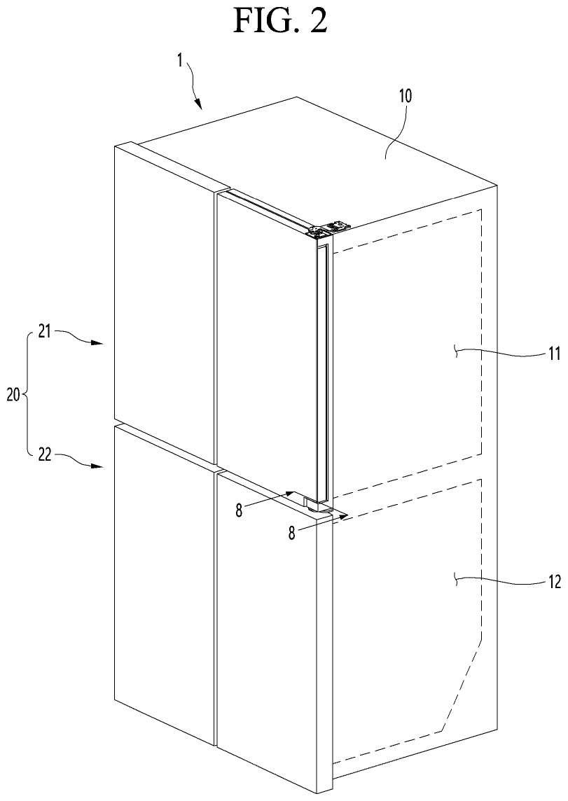

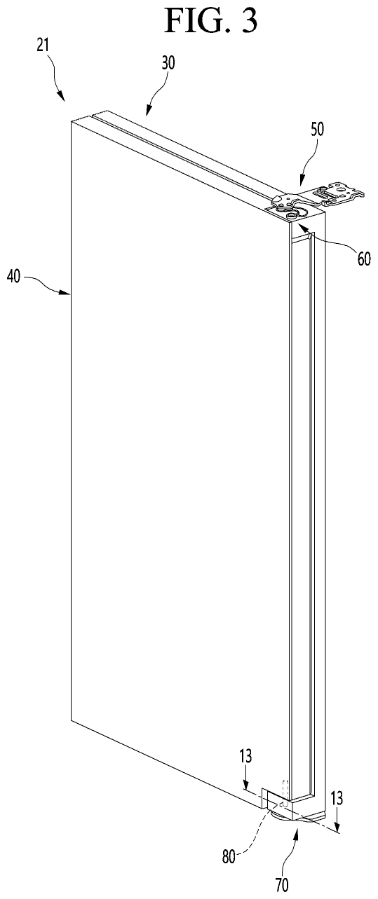

FIG. 1 is a drawing showing a refrigerator received in a furniture cabinet according to a first embodiment. FIG. 2 is a perspective view of a refrigerator according to a first embodiment. FIG. 3 is a perspective view of a first door according to a first embodiment.

Referring to FIGS. 1 to 3, a refrigerator 1 according to the present embodiment may be independently installed at a kitchen or accommodated within an indoor furniture cabinet (hereinafter collectively referred to as a “furniture cabinet”).

When the refrigerator 1 is installed within an indoor furniture cabinet, a refrigerator 1 may be installed independently or arranged left and right with another refrigerator.

The refrigerator 1 may include a cabinet 10 having a storage space. The refrigerator 1 may further include a door 20 that opens and closes the storage space.

The storage space may be divided into, but is not limited to, a first space at an upper side and a second space at a lower side. The door 20 may also include a first door 21 than opens and closes the first space and a second door 22 that opens and closes the second space.

The first space may be a refrigerating chamber and the second space may be a freezing chamber, or vice versa. Alternatively, the storage space may include a first space and a second space divided left and right. Alternatively, the storage space may be a single space, and a single door may open and close the storage space.

At least one of the first door 21 or the second door 22 may be a rotary door. Alternatively, a single door 20 may be a rotary door. Hereinafter, a rotary type door 20 will be described, with the first door 21 as an example.

Hereinafter, an example of opening and closing the first space 11 with multiple first doors 21 arranged left and right will be described.

At least one of a plurality of first doors 21 may include a main door (or inner door) 30 and a sub door (or outer door) 40 rotatable with respect to the main door 30.

The main door 30 may open and close the first space 11. The main door 30 may include an opening.

In a state in which the main door 30 is closed, the opening may be communicated with the first space 21.

The sub door 40 may form part or all of a front exterior of the first door 21. The sub door 40 may open and close the opening of the main door 30. A left-right width of the sub door 40 may be the same as or similar to a left-right width of the main door 30.

The sub door 40 may be formed with a structure that restricts a transmission of light. Alternatively, the sub door 40 may include a door frame having an opening and a panel assembly to cover the opening. In this case, the panel assembly may include one or more panels that allow the transmission of light.

If the sub door 40 includes a panel assembly that allows light to pass through, in a state in which the main door 30 and the sub door 40 are closed and a lighting unit provided at the cabinet 10 or the main door 30 is turned on, it is possible to check items stored in the main door 30 or items stored in the cabinet 10 through the panel assembly.

When the main door 30 rotates, the sub door 40 may rotate together with the main door 30.

The main door 30 may be rotatably connected to the cabinet 10 by a main hinge device 50 and 70.

The sub door 40 may be rotatably connected to the main door 30 by a sub hinge device 60 and 80.

The main hinge device 50 and 70 may include an upper main hinge device 50 and a lower main hinge device 70.

The upper main hinge device 50 may be connected to an upper side of the main door 30. The lower main hinge device 70 may be connected to a lower side of the main door 30.

The sub hinge device 60 and 80 may include an upper sub hinge device 60 and a lower sub hinge device 80.

The upper sub hinge device 60 may be connected to an upper side of the sub door 40. The lower sub hinge device 80 may be connected to a lower side of the sub door 40.

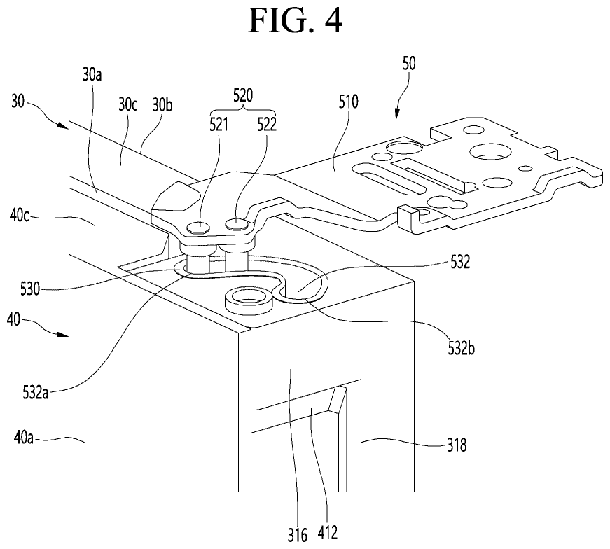

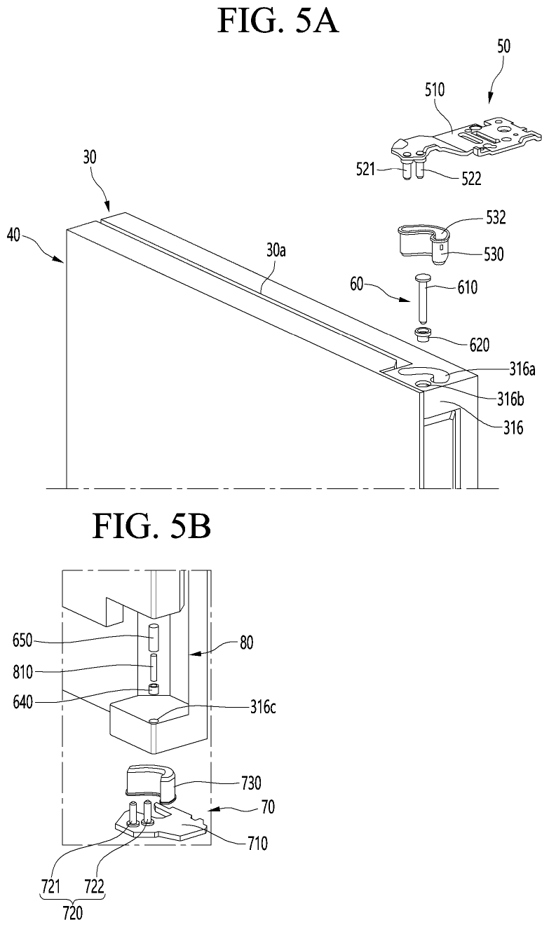

FIG. 4 is a perspective view showing an upper main hinge device and an upper sub hinge device connected to a main door according to a first embodiment. FIG. 5A is an exploded perspective view of an upper main hinge device and an upper sub hinge device, and FIG. 5B is an exploded perspective view of a lower main hinge device and a lower sub hinge device.

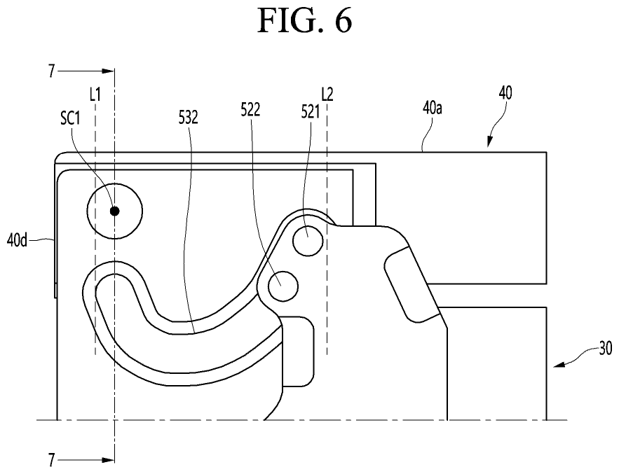

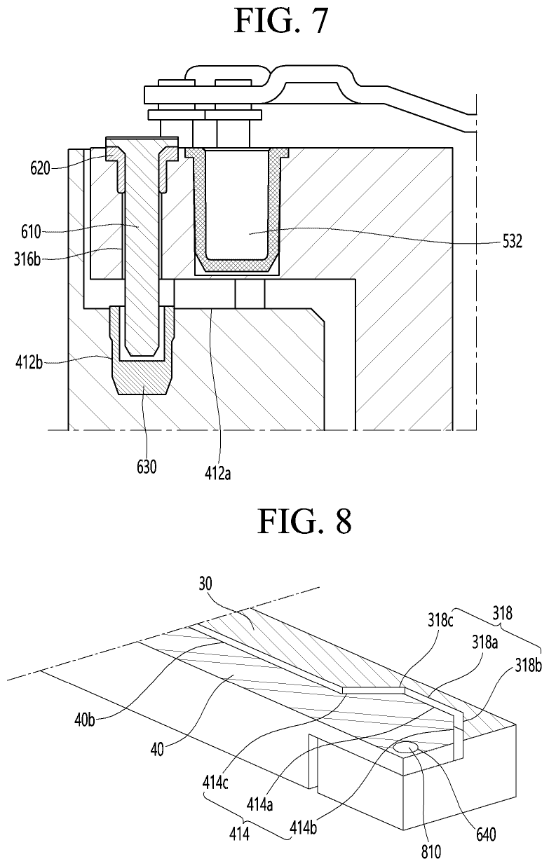

FIG. 6 is a plan view showing an upper main hinge device and an upper sub hinge device connected to a main door. FIG. 7 is a cross-sectional view taken along line 7-7 of FIG. 6. FIG. 8 is a cross-sectional view taken along line 8-8 of FIG. 2.

Referring to FIGS. 4 to 8, structures for rotating the main door 30 in an upper main hinge device 50 and a lower main hinge device 70 of the present embodiment may be formed symmetrically vertically.

An upper sub hinge device 60 and a lower sub hinge device 80 of the present embodiment may be formed symmetrically vertically.

An upper main hinge device 50 of the present embodiment may include a first hinge body 510. The first hinge body 510 may be coupled to an upper surface or a front surface of the cabinet 10. A portion of the first hinge body 510 may overlap an upper side of the main door 30 in a vertical direction. A portion of the first hinge body 510 may overlap an upper side of the sub door 40 in a vertical direction.

The upper main hinge device 50 may further include a first pin unit 520.

The first pin unit 520 may be formed integrally with the first hinge body 510 or may be coupled to the first hinge body 510.

The first pin unit 520 may include a first pin 521 and a second pin 522. The first pin 521 and the second pin 522 may be spaced apart from each other in the first hinge body 510.

The first pin 521 and the second pin 522 may extend from the first hinge body 510 toward the first door 21, for example. The first pin 521 and the second pin 522 may extend downward from the first hinge body 510.

As another example, the first pin 521 and the second pin 522 may be connected by a connecting member. In this case, it may also be understood that the first pin unit 520 includes a single pin. The single pin may be formed in a non-circular shape, but the first pin unit 520 may include a curved surface so as not to interfere with a wall forming the first slot 532, which will be described later, during an opening process of the first door 21. A curvature of at least a portion of the curved surface may be identical to a curvature of the first slot 532.

The upper main hinge device 50 may further include a first guide member 530.

The first guide member 530 may include a first pin slot 532 in which the first pin unit 520 is received.

The first guide member 530 may be coupled to the main door 30. A first groove 316a in which the first guide member 530 is received may be formed in the main door 30.

Alternatively, the first guide member 530 may be omitted, and the first pin slot 532 may be formed in the main door 30. In this case, one wall of the main door 30 may form the first pin slot 532.

The main door 30 may include a first extension 316 extending forward from a front surface 30a of the main door 30. That is, the first extension 316 may extend from a front surface 30a of the main door 30 toward the sub door 40.

As a front-rear thickness of the first door 21 decreases, a thickness of the main door 30 may also decrease. When the thickness of the main door 30 decreases, the first extension 316 needs to be formed in order to secure a space for forming the first pin slot 532. That is, the first extension 316 may protrude forward from a surface of the main door 30 where a gasket of the sub door 40 is in contact (for example, the front surface 30a of the main door 30).

The first extension 316 may protrude from upper and lower sides of the front surface 30a of the main door 30, respectively. That is, a plurality of first extensions 316 may be arranged spaced apart from each other in a vertical direction. Since an upper first extension 316 and a lower first extension are formed in a corresponding shape, only the first extension 316 positioned at an upper side will be described below.

At least a portion of the first pin slot 532 may be positioned at the first extension 316.

The main door 30 may further include a receiving portion 318 that is recessed from a front surface 30a of the main door 30 toward a rear surface 30b. A portion of the sub door 40 may be received in the receiving portion 318. However, when the sub door 40 is formed to be thin, the receiving portion 318 may be omitted.

At least a portion of the first pin slot 532 may be aligned with the receiving portion 318.

For example, a portion of the first pin slot 532 may be positioned in the first extension 316, and another portion of the first pin slot 532 may overlap the receiving portion 318 in a vertical direction.

A portion of the first pin slot 532 may be positioned forward of the front surface 30a of the main door 30, and another portion may be positioned backward of the front surface 30a of the main door 30.

A portion of the first pin slot 532 may overlap the sub door 40 in a vertical direction.

The first pin slot 532 (or the first guide member 530) may include a first end 532a and a second end 532b positioned opposite the first end 532a.

In a state in which the main door 30 is closed, the first pin 521 may be in contact with or be adjacent to the first end 532a. In a state in which the main door 30 is opened by a maximum opening angle, the second pin 522 may be in contact with or be adjacent to the second end 532b.

The first end 532a and the second end 532b may be positioned forward of the front surface 30a of the main door 30. The first end 532a and the second end 532b may be positioned in the first extension 316.

The first pin slot 532 may be extended from the first end 532a in a direction closer to the receiving portion 318 (or a rear surface of the main door) and then bent to extend away from the receiving portion 318 (or the rear surface of the main door).

The upper sub hinge device 60 may include a hinge pin 610. The upper sub hinge device 60 may further include a first bushing 620 in which the hinge pin 610 is received.

The hinge pin 610 may be spaced apart from the first pin 521 and the second pin 523. For example, the hinge pin 610 may be spaced apart from the first pin 521 and the second pin 523 in a horizontal direction.

The first bushing 620 may be coupled to the main door 30. The first bushing 620 may be coupled to, for example, the extension 316 of the main door 30. The hinge pin 610 may pass through the first bushing 620. The main door 30 may include a hinge hole 316b through which the hinge pin 610 passes. The hinge pin 610 may pass through the extension 316.

The upper sub hinge device 60 may further include a second bushing 630 for receiving the hinge pin 610 passing through the hinge hole 316b. The second bushing 630 may be coupled to the sub door 40. A coupling groove 412b for coupling the second bushing 630 may be formed in the sub door 40. The first bushing 620 and the second bushing 630 may form a pin slot for receiving the hinge pin 610.

The sub door 40 may be rotated with respect to the hinge pin 610 as a rotation center SC1.

During an opening process of the main door 30, a rotation center of the main door 30 may be moved. On the other hand, during a rotation process of the sub door 40, a rotation center SC1 of the sub door 40 may be fixed.

Referring to FIG. 6, a rotation center SC1 of the sub door 40 may be positioned in an area between the first virtual line L1 and the second virtual line L2.

Among both side surfaces of the main door 30 or sub door 40, a side surface positioned adjacent to the sub hinge device 60 and 80 may be referred to as a first side surface 40d.

The first virtual line L1 may mean a line perpendicular to a front surface 40a of the sub door 40 while passing through a point where a horizontal distance from the first side surface 40d in the first pin slot 532 is minimum.

The second virtual line L2 may mean a line that is perpendicular to the front surface 40a of the sub door 40 while passing through a point where a horizontal distance from the first side surface 40d in the first pin slot 532 is maximum.

At least a portion of the hinge pin 610 may be positioned in an area between the first virtual line L1 and the second virtual line L2.

A positional relationship between the hinge pin 610 and the first virtual line L1 and the second virtual line L2 in the upper sub hinge device 60 can be equally applied to the lower sub hinge device 80.

The lower main hinge device 70 may include a second pin unit 720, a second hinge body 710, and a second guide member 730 having a second pin slot.

The second pin unit 720 may include a first pin 721 (or a third pin) and a second pin 722 (or a fourth pin) that are spaced apart from each other. The first pin 721 of the second pin unit 720 may be aligned with the first pin 521 of the first pin unit 520 in a vertical direction. The second pin 722 of the second pin unit 720 may be aligned with the second pin 522 of the first pin unit 520 in a vertical direction.

As described above, the second pin unit 720 and the second guide member 730 are formed symmetrically with the first pin unit 520 and the first guide member 530 of the upper main hinge device 50, so a detailed description thereof will be omitted.

The lower sub hinge device 80 may include a hinge pin 810, a first bushing 640, and a second bushing 650. As described above, the lower sub hinge device 80 may be formed in the same shape as the upper sub hinge device 60 or may be formed in a different shape.

In the present embodiment, unlike the upper sub hinge device 60, the lower sub hinge device 80 is illustrated in such a way that the hinge pin 810 does not completely pass through the first extension 316 extending from the main door 30, but rather a portion of the hinge pin 810 is received in the first groove 316c provided in the first extension 316. Of course, it is also possible for the hinge pin 810 to pass through the first extension 316 in the same structure as the upper sub-hinge device 60.

The first bushing 640 may be received in the first groove 316c. The second bushing 650 may be received at a lower side of the sub door 40. A portion of the hinge pin 810 may be coupled to the first bushing 640, and another portion of the hinge pin 810 may be coupled to the second bushing 650.

Meanwhile, the sub door 40 may include a hinge mounting portion 412. The hinge mounting portion 412 may be formed as an upper surface 40c of the sub door 40 is recessed downward. Alternatively, the hinge mounting portion 412 may be formed as one surface of the sub door 40 is recessed toward another surface of the sub door 40.

At least a portion of the first extension 316 may be positioned in a space formed by the hinge member 412. Accordingly, a formation of the first pin slot 532 in the first extension 316 is possible, while interference between the first extension 316 and the sub door 40 can be prevented.

The second bushing 630 and 650 may be coupled to the hinge mounting portion 412. The coupling groove 412 b may be formed at a bottom 412a of the hinge mounting portion 412.

Referring to FIG. 8, the sub door 40 may further include a second extension 414 extending rearward from a rear surface 40b of the sub door 40. That is, the extension 414 may extend from the rear surface 40b of the sub door 40 toward the main door 30. The second extension 414 may be received in the receiving portion 318.

The second extension 414 of the sub door 40 may include a plurality of surfaces that crosses each other.

The plurality of surfaces may include a first surface 414a, a second surface 414b positioned at one side of the first surface 414a, and a third surface 414c positioned at another side of the first surface 414a.

The second surface 414b may be inclined relative to the first surface 414a, and the third surface 414c may be inclined relative to the first surface 414a.

The second surface 414b may extend from one end of the first surface 414a in a direction close to the front surface 40a of the sub door 40. The third surface 414c may extend from another end of the first surface 414a in a direction close to the front surface 40a of the sub door 40.

A width of the second extension 414 may increase as getting closer to the front surface 40a of the sub door 40 from the first surface 414a.

As another example, the second extension 414 may comprise a single rounded surface. The rounded surface may have a constant curvature. Alternatively, the rounded surface may have a variable curvature.

The receiving portion 318 of the main door 30 may be formed in a shape corresponding to or similar to the second extension 414.

In a state in which the second extension 414 is received in the receiving portion 318, the second extension 414 may be spaced apart from a surface forming the receiving portion 318. That is, a gap may be formed between the second extension 414 and the surface forming the receiving portion 318. When the sub door 40 is rotated relative to the main door 30, the second extension 414 can be prevented from interfering with the main door 30 by the gap.

The surface forming the receiving portion 318 may include a plurality of parts that crosses each other.

The plurality of parts may include a first part 318a, a second part 318b positioned at one side of the first part 318a, and a third part 318c positioned at another side of the first surface 318a.

The second part 318b may be inclined relative to the first part 318a, and the third part 318c may be inclined relative to the first part 318a.

In a state in which the sub door 40 is closed, the first side 414a may face the first part 318a. The second side 414b may face the second part 318b. The third side 414c may face the third part 318c.

In the present embodiment, the second extension 414 may be omitted. In this case, the receiving portion 318 may be omitted or a shape of the receiving portion 318 may be changed.

A rotation center SC1 of the sub door 40 may be positioned closer to the front surface 40a of the sub door 40 than the first pin slot 532. At least a portion of the hinge pin 610 and 810 may be positioned closer to the front surface 40a of the sub door 40 than the first pin slot 532.

In a state in which the main door 30 is closed and the main door 30 is opened by a maximum opening angle, the hinge pin 610 and 810 may be positioned closer to the front surface 40a of the sub door 40 than the first pin unit 520.

When a side surface adjacent to the sub hinge device 60 and 80 among both side surfaces of the main door 30 or sub door 40 is referred to as a first side surface 40d, at least a portion of the hinge pin 610 and 810 may be positioned closer to the first side surface 40d than the first pin slot 532.

The hinge pin 610 and 810 may be positioned closer to the first side surface than the first pin unit 520.

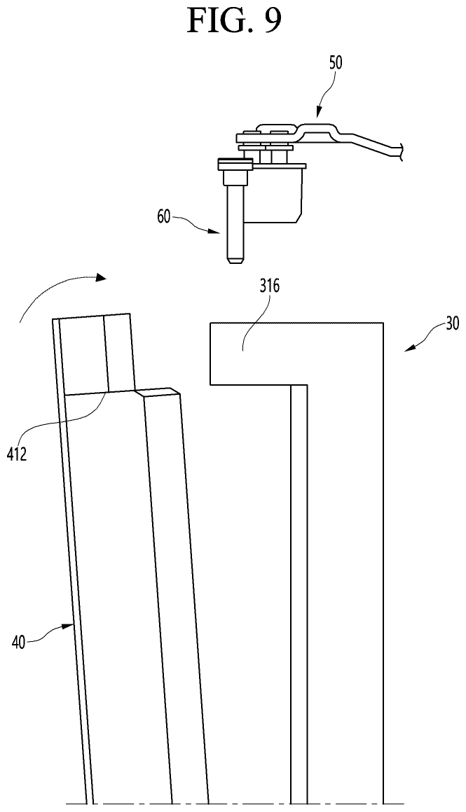

FIG. 9 is a drawing showing a process of coupling a main door and a sub door.

Referring to FIG. 9, when a lower side of the sub door 40 is seated on the main door 30 and an upper side of the sub door 40 is pivoted, the first extension 316 of the main door 30 and the hinge mounting portion 412 of the sub door 40 may be aligned in a vertical direction. In a process of the lower side of the sub door 40 being seated on the main door 30, the lower main hinge device 60 and the lower sub hinge device 80 may be coupled to the main door 30 and the sub door 40.

In this state, the upper main hinge device 50 and the upper sub hinge device 60 may be coupled to the main door 30 and the sub door 40.

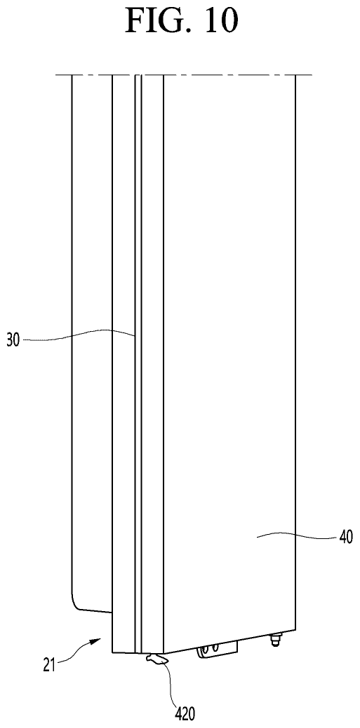

FIG. 10 is a drawing showing a manipulating portion installed at a lower side of a sub door.

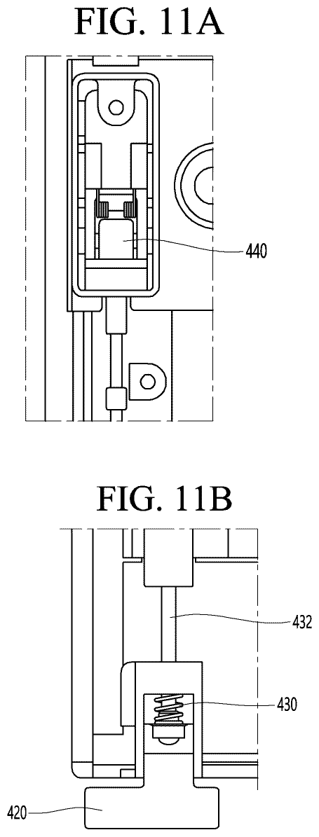

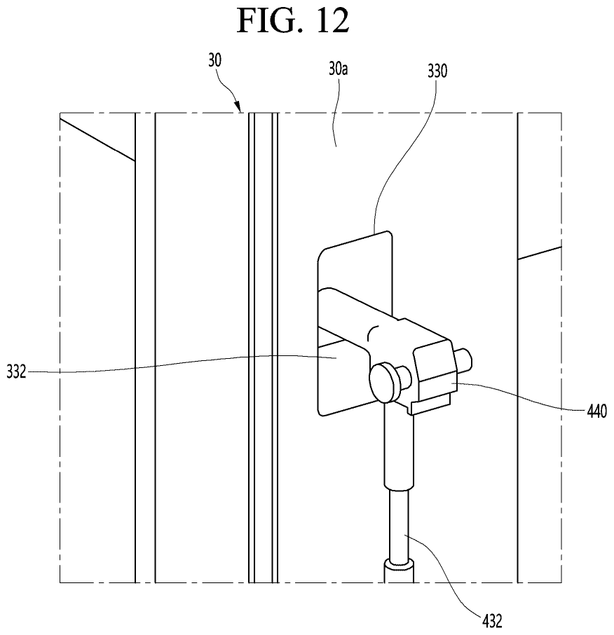

FIG. 11A is a drawing showing a locking device installed at a sub door, and FIG. 11B is a drawing showing a manipulating portion installed at a sub door. FIG. 12 is a drawing showing a state in which a locking portion is hooked to a hook portion of a main door.

Referring to FIGS. 10 to 12, the first door 21 may include a locking device for locking the main door 30 and the sub door 40, and a manipulating portion 420 that a user manipulates to unlock the locking device.

When the main door 30 and the sub door 40 are locked by the locking device, when the main door 30 or the sub door 40 is rotated, the main door 30 and the sub door 40 can be rotated together.

By manipulating the manipulating portion 420, when the main door 30 and the sub door 40 are unlocked, a rotation of the sub door 40 becomes possible in a state in which the main door 30 is closed.

The locking device may include a locking portion 440 that operates by receiving manipulation force of the manipulating portion 420. The locking portion 440 may be rotatably installed at the sub door 40, for example.

The locking device may further include a transfer portion 432 that transfers the manipulation force of the manipulating portion 420 to the locking portion 440. The manipulating portion 420 may be positioned, for example, at a lower side of the sub door 40, and the locking portion 440 may be positioned at an upper side of the manipulating portion 420.

The transfer portion 432 may be positioned between the manipulating portion 420 and the locking portion 440.

The locking device may further include an elastic member 430 that provides elastic force to the manipulating portion 420. The elastic member 430 may provide elastic force so that the manipulating portion 420 moves to an initial position when the manipulation force of the manipulating portion 420 is removed.

The main door 30 may be provided with a space 330 for receiving the locking portion 440. The space 330 may be formed as a front surface of the main door 30 is recessed rearward.

The space 330 may be provided with a hook portion 332 for hooking the locking portion 440.

A state in which the locking portion 440 is hooked on the hook portion 332 is a locked state of the main door 30 and the sub door 40.

A state in which the locking portion 440 are released from the hook portion 332 by manipulating the locking portion 440 by the manipulating portion 420 is an unlocked state of the main door 30 and the sub door 40.

The following describes a process of opening the main door 30 and the sub door 40 together.

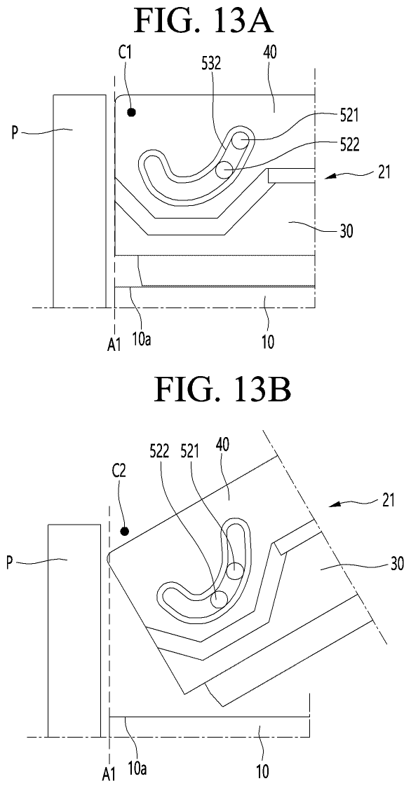

FIG. 13A is a drawing showing a state in which a main door and a sub door are closed, and FIG. 13B is a drawing showing a state in which a main door is opened by a first angle.

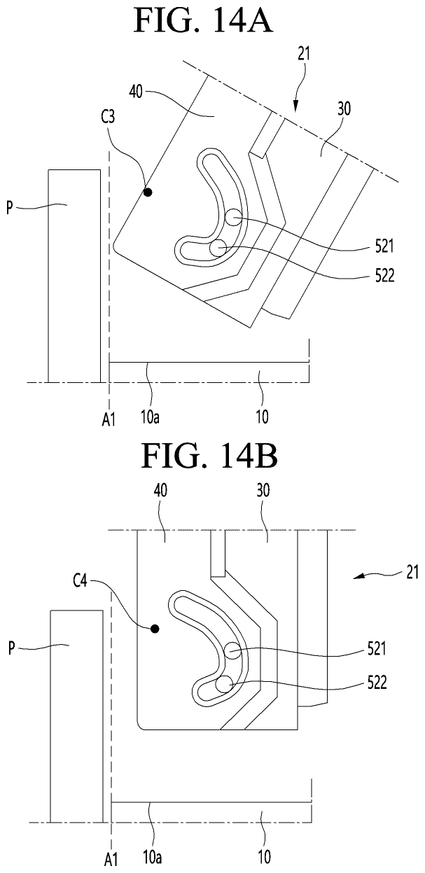

FIG. 14A is a drawing showing a state in which a main door is opened by a second angle greater than a first angle, and FIG. 14B is a drawing showing a state in which a main door is opened by a third angle greater than a second angle.

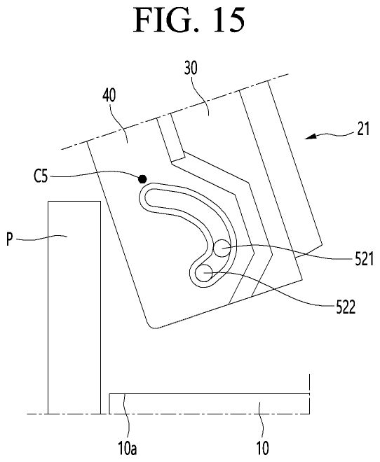

FIG. 15 is a drawing showing a state in which a main door is opened by a maximum opening angle.

In the present invention, when a refrigerator 1 is installed in the furniture cabinet P or is installed in the kitchen, an opening angle of the first door 21 needs to be increased without the first door 21 interfering with the furniture cabinet P during an opening process of the first door 21.

In the present embodiment, the opening angle of the first door 21 can be increased without the first door 21 interfering with the furniture cabinet P by the main hinge device 50 and 70.

For example, the main hinge device 50 and 70 may cause a rotation center of the main door 30 to move in at least a portion of the entire opening period of the main door 30. At this time, the rotation center may move in a direction away from one surface of the furniture cabinet P.

In the present embodiment, the rotation center (or virtual rotation center) of the main door 30 may move depending on a shape of the first pin slot 532.

Depending on a shape of the first pin slot 532, the rotation center of the main door 30 may move continuously or stepwise.

Referring to FIGS. 2 to 15, when the main door 30 and the sub door 40 are in a locked state, when the main door 30 is rotated, the main door 30 and the sub door 40 may be rotated together. Although not shown, a handle may be provided at the sub door 40. At this time, the handle may or may not be provided at the main door 30. Alternatively, the handle may be provided at each of the main door 30 and the sub door 40.

During a rotation process of the main door 30, the first pin slot 532 moves with respect to the first pin unit 520, so that relative positions of the first pin unit 520 and the first pin slot 532 may be changed.

When a curvature of the first pin slot 532 is changed stepwise, the first pin slot 532 may include a plurality of distinct paths. That is, the first pin slot 532 may include a plurality of paths extending in different directions or having different curvatures.

A length of some of the plurality of paths may be different from a length of other of plurality of paths.

Referring to FIG. 13A, when the main door 30 is closed and begins to open, the main door 30 may rotate around a first rotation center C1.

In this specification, the rotation center of the main door 30 may be a virtual rotation center of the main door 30.

The first rotation center C1 may be positioned at the sub door 40. The first rotation center C1 may be positioned at the first extension 316 of the main door 30.

Referring to FIG. 13B, when the main door 30 is rotated by a first angle, the main door 30 may be rotated based on a second rotation center C2. That is, the rotation center of the main door 30 may move in the process of opening the main door 30 by the first angle. The second rotation center C2 may be positioned outside the first door 21. That is, the second rotation center C2 may be positioned outside the main door 30 and the sub door 40.

The second rotation center C2 may be positioned father from the front surface 10a of the cabinet 10 than the first rotation center C1.

Referring to FIG. 14A, when the main door 30 is rotated by a second angle, the main door 30 may be rotated based on a third rotation center C3. That is, the rotation center of the main door 30 may move in the process of opening the main door 30 by the second angle. The third rotation center C3 may be positioned at the sub door 40.

The third rotation center C3 may be positioned closer to the front surface 10a of the cabinet 10 than the second rotation center C2.

A virtual line A1 extending in a front-back direction from a first side surface adjacent to the first pin unit 520 among two side surfaces of the cabinet 10 may be defined.

At this time, a distance between the virtual line A1 and the third rotation center C3 may be greater than a distance between the virtual line A1 and the second rotation center C2.

Referring to FIG. 14B, when the main door 30 is rotated by a third angle, the main door 30 may be rotated based on a fourth rotation center C4. That is, the rotation center of the main door 30 may move in the process of opening the main door 30 by the third angle. The fourth rotation center C4 may be positioned at the sub door 40.

The fourth rotation center C4 may be positioned father away from the front surface 10a of the cabinet 10 than the third rotation center C3.

A distance between the virtual line A1 and the fourth rotation center C4 may be greater than a distance between the virtual line A1 and the third rotation center C3.

Referring to FIG. 15, immediately before the main door 30 is opened by a maximum opening angle, the main door 30 may be rotated based on a fifth rotation center C5. The fifth rotation center C5 may be positioned at the sub door 40.

The fifth rotation center C5 may be positioned farther from the front surface 10a of the cabinet 10 than the fourth rotation center C4.

A distance between the virtual line A1 and the fifth rotation center C4 may be less than a distance between the virtual line A1 and the fourth rotation center C4.

In the present embodiment, the rotation center of the main door 30 may move away from the front surface 10a of the cabinet 10 in at least a period of the entire opening period of the main door 30.

In another period of the entire opening period of the main door 30, the rotation center of the main door 30 may move in a direction closer to the front surface 10a of the cabinet 10.

In another period of the entire opening period of the main door 30, the rotation center of the main door 30 may move in a direction away from the virtual line A1 (or one surface of the furniture cabinet).

In another period of the entire opening period of the main door 30, the rotation center of the main door 30 may move in a direction closer to the virtual line A1.

In at least a period of the entire opening period of the main door 30, the rotation center of the main door 30 may be positioned farther from the front surface 10a of the cabinet 10 than the rotation center SC1 of the sub door 40.

Next, a process of rotating the sub door 40 will be described.

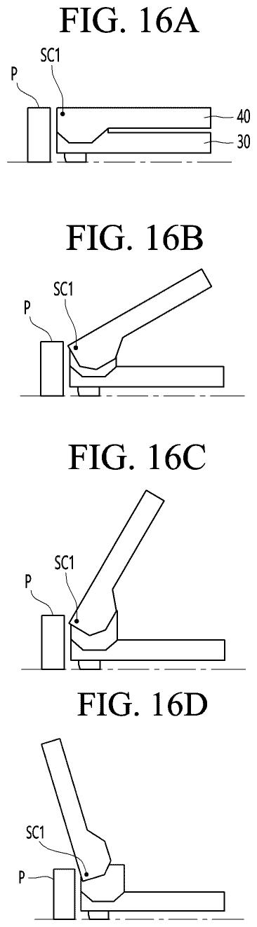

FIGS. 16A to 16D are drawings illustrating a rotation of a sub door in a state in which a main door is closed.

Referring to FIGS. 16A to 16D, the sub door 40 may be rotated based on a rotation center SC1. During a rotation process of the sub door 40, a position of the rotation center SC1 may be fixed. Since the rotation center SC1 is positioned close to a corner of the sub door 40, the sub door 40 can be rotated without interfering with the furniture cabinet P during the rotation process of the sub door 40.

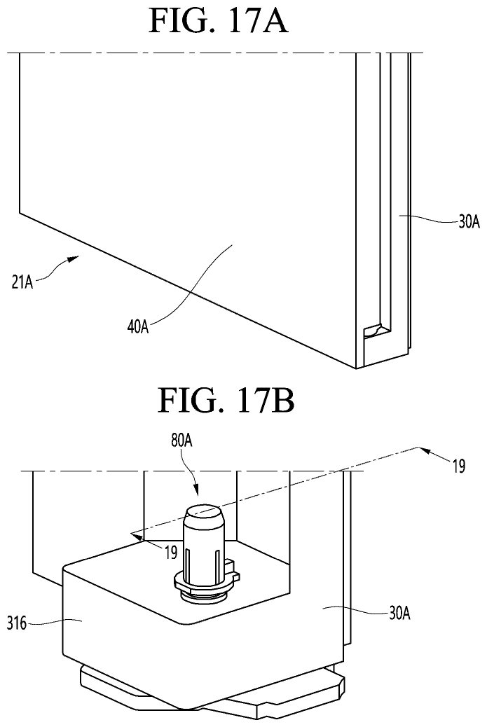

FIG. 17A is a perspective view of a first door according to a second embodiment, and FIG. 17B is a drawing showing a sub hinge device according to a second embodiment.

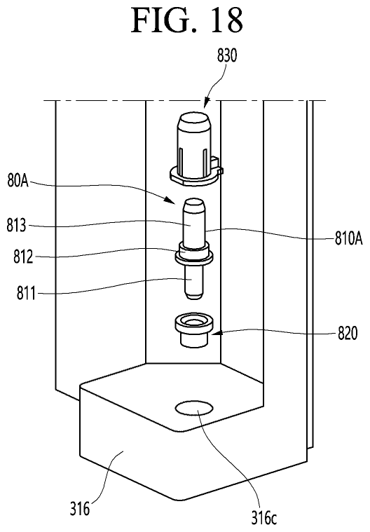

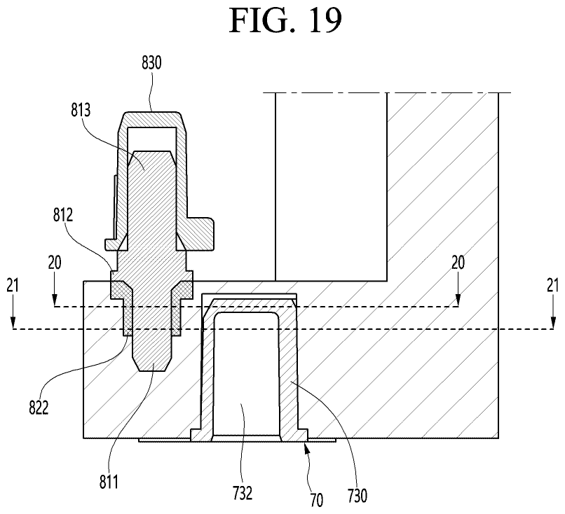

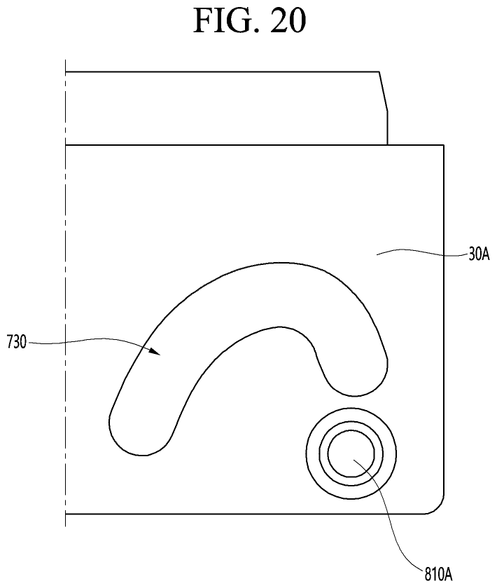

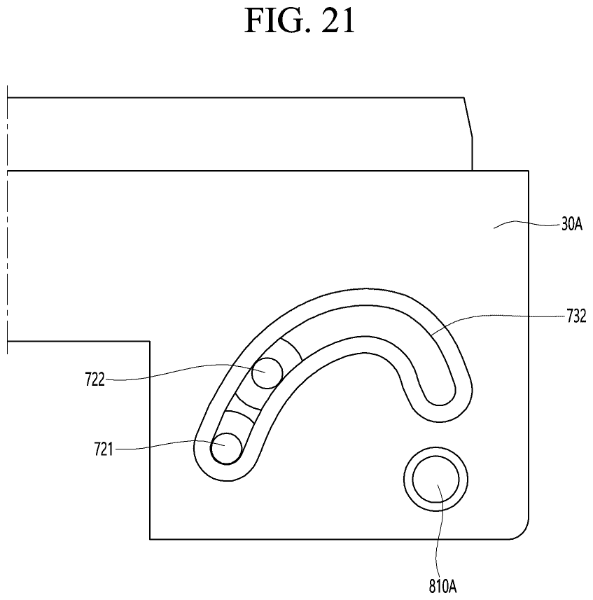

FIG. 18 is an exploded perspective view of a sub hinge device according to a second embodiment. FIG. 19 is a cross-sectional view taken along line 19-19 of FIG. 17B. FIG. 20 is a cross-sectional view taken along line 20-20 of FIG. 19. FIG. 21 is a cross-sectional view taken along line 21-21 of FIG. 19.

This embodiment is identical to the first embodiment in other respects, except that it differs a sub hinge device. Therefore, only characteristic parts of this embodiment will be described below.

Referring to FIGS. 17A to 21, a door 21A of the present embodiment may include a main door 30A and a sub door 40A.

The sub door 40A may be rotatably connected to the main door 30A by a sub hinge device 80A.

The main door 30A may include an extension 316. One end of the sub hinge device 80A may be connected to the extension 316. Another end of the sub hinge device 80A may be connected to the sub door 40A.

The sub hinge device 80A may include a hinge pin 810A. The hinge pin 810A may provide a rotation center for the sub door 40A.

The hinge pin 810 may include a first pin 811 coupled to the main door 30A and a second pin 813 coupled to the sub door 40A.

A flange 812 may be provided between the first pin 811 and the second pin 813.

The sub hinge device 80A may further include a first bushing 820 coupled to the main door 30A. The first pin 811 may be received in the first bushing 820.

A first groove 316c may be formed in the extension 316 of the main door 30A to which the first bushing 820 is coupled.

The sub hinge device 80A may further include a second bushing 830 coupled to the sub door 40A. The second pin 813 may be received in the second bushing 830.

In this embodiment, the hinge pin 810A does not pass through the extension 316 of the main door 30A, and a portion of the hinge pin 810A may be inserted into the extension 316.

Meanwhile, the main door 30A may be rotated relative to the cabinet 10 by the main hinge device 70.

The main hinge device 70 may include a pin unit comprising a first pin 721 and a second pin 722, and a guide member 730 in which a pin slot 732 for receiving the pin unit is formed.

In the present embodiment, the hinge pin 810A may include a portion positioned closer to the front surface of the sub door 30A than the pin slot 732.

Even in the present embodiment, a rotation center of the main door 30A may be moved by the main hinge device 70.

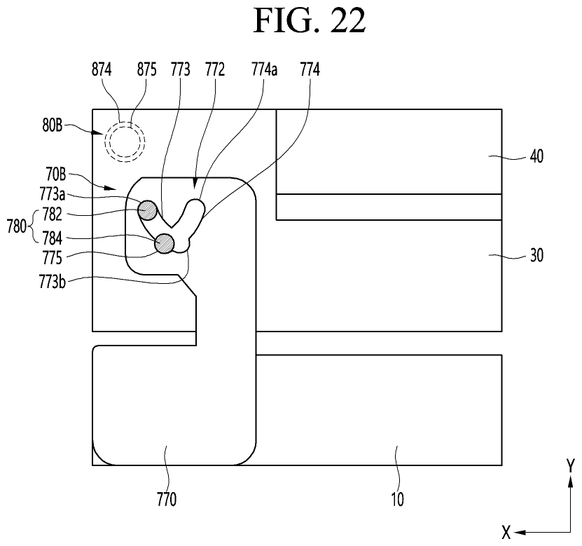

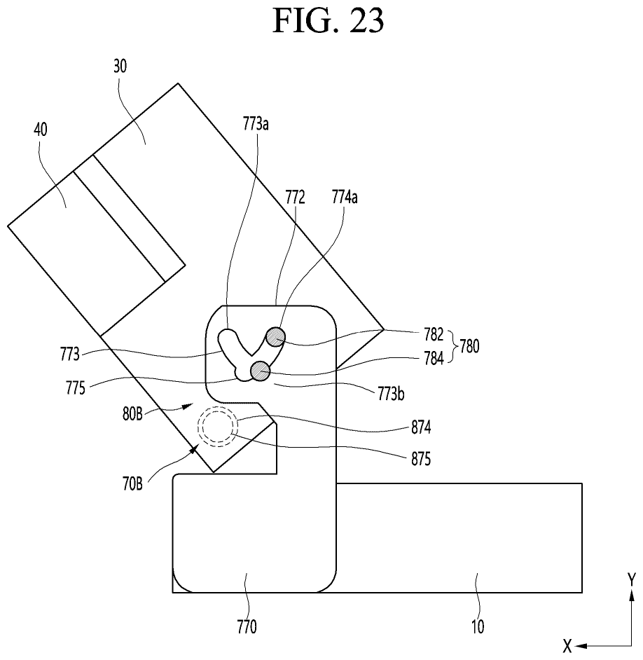

FIG. 22 is a plan view showing a first door according to a third embodiment. FIG. 23 is a drawing showing a state in which a main door is opened by a maximum opening angle according to a third embodiment.

This embodiment is identical to the first embodiment in other respects, except that there is a difference in positions of the first pin unit and the first pin slot. Therefore, only characteristic parts of this embodiment will be described below. The same drawing reference numerals will be used for the same components as the first embodiment.

Referring to FIGS. 22 and 23, a first door 21 of the present embodiment may include a main door 30 and a sub door 40.

In the present embodiment, the main door 30 may be rotated by a main hinge device 70B, and the sub door 40 may be rotated by a sub hinge device 80B.

The main hinge device 70B may include a hinge body 770 having a pin slot 772, and a pin unit 780.

The sub hinge device 80B may include a hinge pin 875. The sub hinge device 80B may include a bushing 874. A structure of the sub hinge device 80B may be the same as a structure of the sub hinge device described in the first or second embodiment, and thus a detailed description thereof will be omitted.

The pin unit 780 may be, for example, coupled to an upper side of the main door 30 or formed integrally with the main door 30.

The pin unit 780 may include a first pin 782 and a second pin 784 that are spaced apart from each other.

The first pin 782 and the second pin 784 may be formed integrally with the main door 30. Alternatively, the pin unit 780 may include a plate supporting the first pin 782 and the second pin 784, and the plate may be coupled to the main door 30.

The first pin 782 and the second pin 784 may be spaced apart in a front-back direction (or Y-axis direction) of the refrigerator or in an arrangement direction of the cabinet 10 and the first door 21. In addition, the first pin 782 and the second pin 784 may also be spaced apart in an X-axis direction crossing the Y-axis direction.

The pin slot 772 may be a hole through which the first pin 782 and the second pin 784 pass, or a groove into which the first pin 782 and the second pin 784 are inserted.

The pin slot 772 may include a first slot portion 773. The first slot portion 773 may extend in a direction crossing the X-axis and the Y-axis. The first slot portion 773 may guide the first pin 782 during an opening and closing process of the main door 30. The first slot portion 773 may extend in a curved shape.

The pin slot 772 may further include a second slot portion 774 extending from the first slot portion 773. The second slot portion 774 may extend at a position spaced apart from both ends 773a and 773b of the first slot portion 773. The second slot portion 774 may guide the second pin 784 during the opening and closing process of the main door 30. The second slot portion 774 may extend in a curved shape.

The pin slot 772 may further include a third slot portion 775 extending from the first slot portion 773. The third slot portion 775 may be positioned at an opposite side of the second slot portion 774 in the first slot portion 773.

In a state in which the main door 30 is closed, the hinge pin 875 may be positioned closer to the front surface of the sub door 40 than the first pin 782 and the second pin 784.

In a process of closing the main door 30, the first pin 782 may be in contact with or adjacent to the first end 773a, and the second pin 784 may be in contact with or adjacent to an end of the third slot portion 775.

In a process of opening the main door 30 to a maximum opening angle, the first pin 782 may be in contact with or adjacent to an end 774a of the second slot portion 774, and the second pin 784 may be in contact with or adjacent to the second end 773b of the first slot portion 773.

In a state in which the main door 30 is opened to the maximum opening angle, the first pin 782 and the second pin 784 may be positioned closer to the front surface of the sub door 40 than the hinge pin 875.

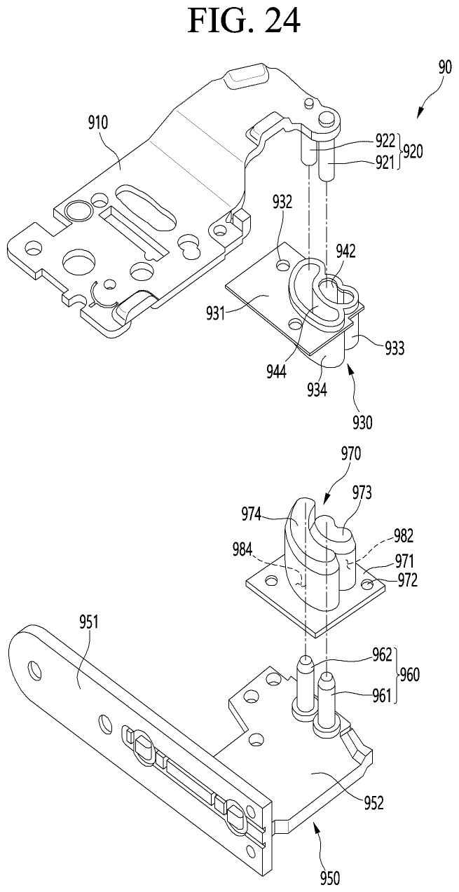

FIG. 24 is a perspective view showing a main hinge device according to a fourth embodiment.

This embodiment is identical to the first embodiment in other respects, except that it differs a shape of the guide member. Therefore, only characteristic parts of this embodiment will be described below.

Referring to FIG. 24, a main hinge device of the present embodiment may include an upper main hinge device 90 and a lower main hinge device 950.

The upper main hinge device 90 may include a first hinge body 910 and a first pin unit 920.

The first pin unit 920 may, for example, extend from the first hinge body 910 toward the main door 30. The first pin unit 920 may extend downward from the first hinge body 910.

The first pin unit 920 may include a first pin 921 and a second pin 922. The first pin 921 and the second pin 922 may be spaced apart from each other in the first hinge body 910.

A basic shape and function of the first pin 921 and the second pin 922 are the same as the first pin and the second pin of the first embodiment, so a detailed description thereof will be omitted.

The upper main hinge device 90 may include a first guide member 930. The first guide member 930 may be provided at the main door 30. The first guide member 930 may form a first pin slot.

The first pin slot may include a first slot 942 in which the first pin 921 is received, and a second slot 944 in which the second pin 922 is received. The first slot 942 and the second slot 944 may be separated from each other and spaced apart from each other.

The first guide member 930 may include an extension 931 coupled to the main door 30. A coupling hole 932 through which a coupling member passes may be formed in the extension 931. The coupling member may be coupled to the main door 30 by passing through the coupling hole 932.

The first guide member 930 may include a first body part 933 forming the first slot 942 and a second body part 934 forming the second slot 944. The first body part 933 and the second body part 934 may extend from the extension 931.

A lower main hinge device 950 of the present embodiment may include a second hinge body and a second pin unit 960.

The second hinge body may include, for example, a coupling portion 951 coupled to the cabinet 10 and an extension 952 extending from the coupling portion 951. The second pin unit 960 may be provided at the extension 952.

The second pin unit 960 may, for example, extend upward from the extension 952.

The second pin unit 960 may include a first pin 961 and a second pin 962. The first pin 961 and the second pin 962 may be spaced apart from each other in the extension 952.

The lower main hinge device 950 may further include a second guide member 970. The second guide member 970 may be provided at the main door 30.

The second guide member 970 may form a second pin slot.

The second pin slot may include a first slot 982 in which the first pin 961 is received, and a second slot 984 in which the second pin 962 is received. The first slot 982 and the second slot 984 may be spaced apart from each other.

The second guide member 970 may include an extension 971 coupled to the main door 30. A coupling hole 972 through which a coupling member passes may be formed in the extension 971. The coupling member may be coupled to the main door 30 by passing through the coupling hole 942.

The second guide member 970 may include a first body part 973 forming the first slot 982 and a second body part 974 forming the second slot 984. The first body part 973 and the second body part 974 may extend from the extension 971.

A rotation center of the main door 30 can also be moved by the upper main hinge device 90 and the lower main hinge device 950 of the present embodiment.

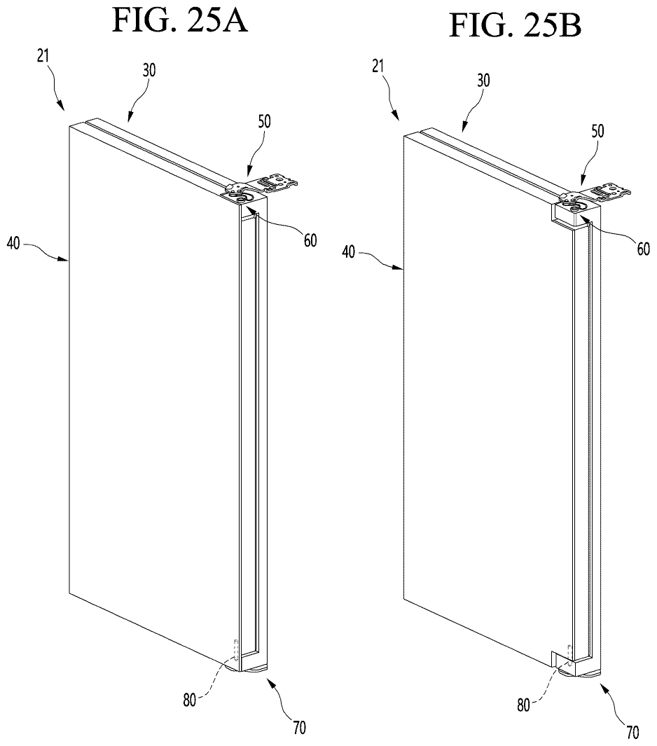

FIG. 25A shows a first modified example of a first door, and FIG. 25B shows a second modified example of a first door.

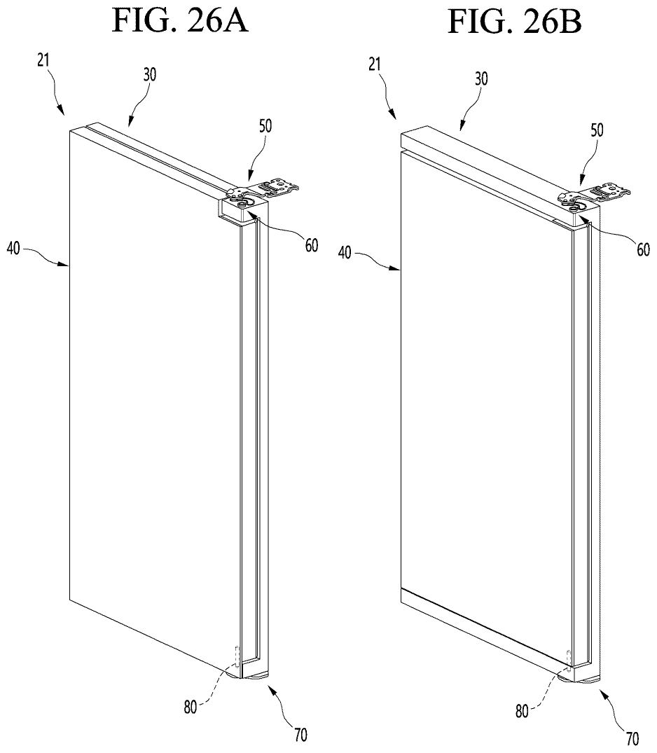

FIG. 26A illustrates a third modified example of a first door, and FIG. 26B illustrates a fourth modified example of a first door.

In FIGS. 25 and 26, in a modified example of the first door, a basic structure for rotation of the main door and sub door is the same as that described in the previous embodiments, except that a shape of one or more of the main door and sub door is changed.

First, referring to FIG. 3, an upper portion of the sub door 40 covers a front surface of the main door 30, while a lower portion of the sub door 40 is cut off so that a portion (e.g., a first extension) to which a hinge is coupled at the main door 30 may form the front exterior of the first door 21.

Referring to FIG. 25A, an entirety of the sub door 40 may cover a front surface of the main door 30. That is, a front surface of the sub door 40 may form a front surface of the first door 21.

Referring to FIG. 25B, upper and lower portions of the sub door 40 may be cut off so that a portion (e.g., the first extension) to which the hinge is connected in the main door 30 may form a front exterior of the first door 21.

Referring to FIG. 26A, a lower portion of the sub door 40 covers the front surface of the main door 30, while an upper portion of the sub door 40 is cut off so that a portion (e.g., a first extension) to which a hinge is coupled in the main door 30 may form a front exterior of the first door 21.

Referring to FIG. 26B, a vertical length of the sub door 40 may be formed to be less than a vertical length of the main door 30. The sub door 40 may be received in a receiving portion formed at a front surface of the main door 30. In a case of the present modified example, upper and lower portions of a front exterior of the first door 21 may be formed by the main door 30, and a portion between the upper and lower portions of the front exterior of the first door 21 may be formed by the sub door 40.

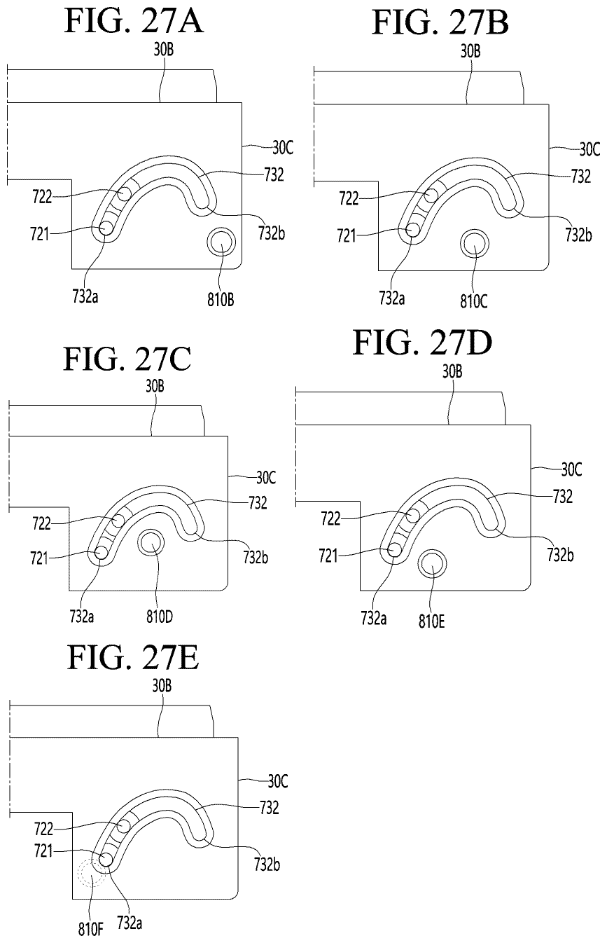

FIGS. 27A to 27E are drawings showing various embodiments of an arrangement between a pin slot of a main door and a hinge pin of a sub door.

First, referring to FIG. 27A, a pin slot 732 of the main door 30 may include a first end 732a and a second end 732b.

Corresponding to a description in the first embodiment, in a state in which the main door 30 is closed, the first pin 721 may be in contact with or be adjacent to the first end 732a. In a state in which the main door 30 is opened by a maximum opening angle, the second pin 722 may be in contact with or be adjacent to the second end 732b.

Among two side surfaces of the main door 30, a side surface adjacent to the pin slot 732 may be referred to as a first side surface 30C.

In a state in which the main door 30 is closed, the second end 732b may be positioned closer to the first side surface 30C than the first end 732a.

At least a portion of the hinge pin 810B of the sub door 40 may be positioned closer to the first side surface 30C than the second end 732b.

Referring to FIG. 27B, in a state in which the main door 30 is closed, the hinge pin 810C of the sub door 40 may be positioned to face an area between the first end 732a and the second end 732b. For example, in a state in which the main door 30 is closed, the hinge pin 810C may be positioned closer to the first pin 721 than the second end 732b. In a state in which the main door 30 is closed, the second end 732b may be positioned closer to the first side surface 30C than the hinge pin 810C.

Referring to FIG. 27C, in a state in which the main door 30 is closed, at least a portion of the hinge pin 810D of the sub door 40 may be positioned closer to a rear surface 30B of the main door 30 than the first end 732a. At least a portion of the hinge pin 810D of the sub door 40 may be positioned farther from the rear surface 30B of the main door 30 than the second end 732b. In a state in which the main door 30 is closed, the second end 732b may be positioned closer to the first side surface 30C than the hinge pin 810C.

A line connecting the first end 732a and the second end 731b may overlap the hinge pin 810D in a vertical direction. Alternatively, the hinge pin 810D may be positioned within an area formed by the pin slot 732 and a line connecting the first end 732a and the second end 731b.

Referring to FIG. 27D, in a state in which the main door 30 is closed, the hinge pin 810E of the sub door 40 may be positioned closer to the first end 732a than the second end 732b. At least a portion of the hinge pin 810E of the sub door 40 may be positioned farther from the rear surface 30B of the main door 30 than the first end 732a.

Referring to FIG. 27E, in a state in which the main door 30 is closed, at least a portion of the hinge pin 810F may be positioned farther from the first side surface 30c than each of the first end 732a and the second end 732b. At least a portion of the hinge pin 810E of the sub door 40 may be positioned farther from the rear surface 30B of the main door 30 than the first end 732a.

What is claimed is:

1. A home appliance comprising:
a cabinet having a storage space;
a main door configured to open and close at least a portion of the storage space;
a sub door rotatable with respect to the main door;
a main hinge device configured to allow the main door to rotate with respect to the cabinet; and
a sub hinge device configured to allow the sub door to rotate with respect to the main door,
wherein the main hinge device includes:
a hinge body installed at the cabinet,
a pin unit provided at one of the hinge body and the main door, and
a pin slot in which the pin unit is received and provided at another of the hinge body and the main door,
wherein the sub hinge device includes a hinge pin that provides a rotation center for the sub door, and
wherein, during an opening process of the main door, relative positions of the pin slot and the pin unit vary, and a rotation center of the main door moves.

2. The home appliance of claim 1, wherein, during a rotation process of the sub door, the rotation center of the sub door is fixed in position.

3. The home appliance of claim 1, wherein in a state in which the main door is closed, at least a portion of the hinge pin is positioned closer to a front surface of the sub door than the pin slot.

4. The home appliance of claim 1, wherein in a state in which the main door is closed, the hinge pin is positioned closer to a front surface of the sub door than the pin unit.

5. The home appliance of claim 1, wherein when a side surface of the sub door adjacent to the sub hinge device among both side surfaces of the sub door is referred to as a first side surface, in a state in which the main door is closed, at least a portion of the hinge pin is positioned closer to the first side surface than the pin slot, or at least a portion of the pin slot is positioned closer to the first side surface than the hinge pin.

6. The home appliance of claim 1, wherein when a side surface of the sub door adjacent to the sub hinge device among both side surfaces of the sub door is referred to as a first side surface, in a state in which the main door is closed, the hinge pin is positioned closer to the first side surface than the pin unit, or the pin unit is positioned closer to the first side surface than the hinge pin.

7. The home appliance of claim 1, wherein in at least a period of an entire opening period of the main door, the rotation center of the main door is positioned farther from a front surface of the cabinet than the rotation center of the sub door.

8. The home appliance of claim 1, wherein the main door includes:
an extension extending from a front surface of the main door toward the sub door, and
at least a portion of the pin slot is positioned at the extension.

9. The home appliance of claim 8, wherein the sub door includes:
a hinge mounting portion at which the extension is positioned, and
at least a portion of the hinge pin is positioned at the hinge mounting portion.

10. The home appliance of claim 1, wherein at least a portion of the pin slot overlaps the sub door in a vertical direction.

11. The home appliance of claim 1, wherein the sub hinge device further includes:
a first bushing provided at the main door, and
a second bushing provided at the sub door, and
wherein the hinge pin is received in the second bushing by passing through the first bushing.

12. The home appliance of claim 1, wherein the sub hinge device further includes:
a first bushing provided at the main door, and
a second bushing provided at the sub door, and
wherein the hinge pin includes a first pin received in the first bushing and a second pin received in the second bushing.

13. The home appliance of claim 1, wherein the pin unit includes a first pin and a second pin that are spaced apart from each other, and
wherein the first pin and the second pin are received in the pin slot.

14. The home appliance of claim 1, wherein the pin unit includes a first pin and a second pin that are spaced apart from each other, and
wherein the pin slot includes:
a first slot that receives the first pin, and
a second slot that is partitioned from the first slot and receives the second pin.

15. The home appliance of claim 11, wherein in a period of an entire opening period of the main door, the rotation center of the main door moves away from a front surface of the cabinet, and
wherein, in another period of the entire opening period of the main door, the rotation center of the main door moves toward the front surface of the cabinet.

16. The home appliance of claim 1, wherein in a period of an entire opening period of the main door, the rotation center of the main door is positioned outside the sub door and the main door.

17. A home appliance comprising:
a cabinet having a storage space;
a main door configured to open and close at least a portion of the storage space;
a sub door rotatable with respect to the main door;
a main hinge device configured to allow the main door to rotate with respect to the cabinet; and
a sub hinge device configured to allow the sub door to rotate with respect to the main door,
wherein the main hinge device comprises:
a hinge body installed at the cabinet;
first and second pins provided at one of the hinge body and the main door and spaced apart from each other; and
a pin slot in which the first and second pins are received and provided at another of the hinge body and the main door,
wherein the sub hinge device includes a hinge pin that provides a rotation center of the sub door and is spaced apart from the first pin and the second pin.

18. The home appliance of claim 17, wherein, in a state in which the main door is closed, the hinge pin is positioned closer to a front surface of the sub door than the first pin and the second pin.

19. The home appliance of claim 18, wherein, in a state in which the main door is opened by a maximum opening angle, the hinge pin is positioned closer to the front surface of the sub door than the first pin and the second pin.

20. The home appliance of claim 18, wherein, in a state in which the main door is opened by a maximum opening angle, the first pin and the second pin are positioned closer to the front surface of the sub door than the hinge pin.
